(19) United States
(12) Patent Application Publication
(10) Pub. No.: US 2018/0184568 A1
(43) Pub. Date: Jul. 5, 2018

(54) Gardening Tool

(71) Applicant: Bradley Martin, Stanwood, WA (US)

(72) Inventor: Bradley Martin, Stanwood, WA (US)

(21) Appl. No.: 15/394,057

(22) Filed: Dec. 29, 2016

(51) Int. Cl. A01B 1/16; A01B 1/20; A01D 7/00

(52) U.S. Cl. CPC A01B 1/16; A01D 7/00; A01B 1/20

(57) ABSTRACT

A gardening tool may have a handle coupled to a head by way of a connector. The head may comprise a detachable, double-edged blade having a plurality of spikes. The head may include a second blade with a plurality of prongs of varying lengths. The smaller size of the gardening tool relative to many conventional tools may improve efficiency for the use, transportation, and storage of the tools.

### FIELD

This disclosure relates to a gardening tool.

### BACKGROUND

Gardeners, farmers, and other laborers often experience difficulty breaking through roots, weeds, and other matter in the earth. The use of conventional tools such as rakes, picks, and hoes, for example, typically require a user to expend a significant amount of time and energy to break through tough soil. This may result in high labor costs, muscle strain or injury to a user, or damage to existing crops, for example. Many conventional tools are also large or bulky and difficult to use, store, and transport.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, a Gardening Tool, which may comprise a head configured to couple to a handle by way of a connector piece. The head may comprise a detachable, double-edged blade having a plurality of spikes. The head may include a second blade with a plurality of prongs of varying lengths. According to one embodiment, the connector piece may have a small tubing at its first end, which may fit into a connector receptacle in the Gardening Tool head. The connector piece may have a hollow, elongated cylinder at a second end, which may receive the handle. The connector piece may securely attach to the head and handle by an attachment means such as screws or bolts, for example. In another embodiment, the connector piece may comprise a head configured to securely attach a blade at its first end and to securely attach a handle at its second end.

The smaller size of Gardening Tool relative to many conventional tools may improve efficiency for uses such as cultivation, removal of weeds, moss, or debris from gravel, soil, root material, and mulch areas, or leveling of plant or flower beds, among many other uses, as well as for transport and storage of the tools.

A person skilled in the art will understand that a Gardening Tool may be made in various shapes and sizes, and of various materials, such as wood, plastic, rubber, metal, or carbon fiber, for example.

Many of the attendant features may be more readily appreciated as they become better understood by reference to the following detailed description considered in connection with the attached drawings, in which like numerals reference like parts.

### BRIEF DESCRIPTION OF THE DRAWINGS

FIG. 1 is a top perspective view of a Gardening Tool 100, according to one embodiment.

FIG. 2 is a front view of a Gardening Tool 100, according to one embodiment.

FIG. 3 is a side view of a Gardening Tool 100, according to one embodiment.

FIG. 4 is a side view of Connector 150 of Gardening Tool 100, according to one embodiment.

FIG. 5 is a side view of Gardening Tool 500, according to one embodiment.

FIG. 6 is a front view of the head of a Gardening Tool 500, according to one embodiment.

FIG. 7 is a side view of Connector 550 of Gardening Tool 500, according to one embodiment.

FIG. 8 is a side view of a head of Gardening Tool 500, according to one embodiment.

FIG. 9 is a side view of a Gardening Tool 900, according to one embodiment.

FIG. 10 is a front view of a Gardening Tool 900 head, according to one embodiment.

FIG. 11 is a top perspective view of a Gardening Tool 1100, according to one embodiment.

FIG. 12 is a side perspective view of a Gardening Tool 1100, according to one embodiment.

FIG. 13 is a side perspective view of a Gardening Tool 1300, according to one embodiment.

FIG. 14 is a perspective view of a Gardening Tool 1300, according to one embodiment.

FIG. 15 is a side view of a Gardening Tool 1300, according to one embodiment.

FIG. 16 is a side view of a Gardening Tool 1600, according to one embodiment.

FIG. 17 is a front perspective view of a Gardening Tool 1700, according to one embodiment.

FIG. 18 is a bottom perspective view of a Gardening Tool 1800, according to one embodiment.

FIG. 19 is a side view of a Gardening Tool 1800, according to one embodiment.

### DETAILED DESCRIPTION

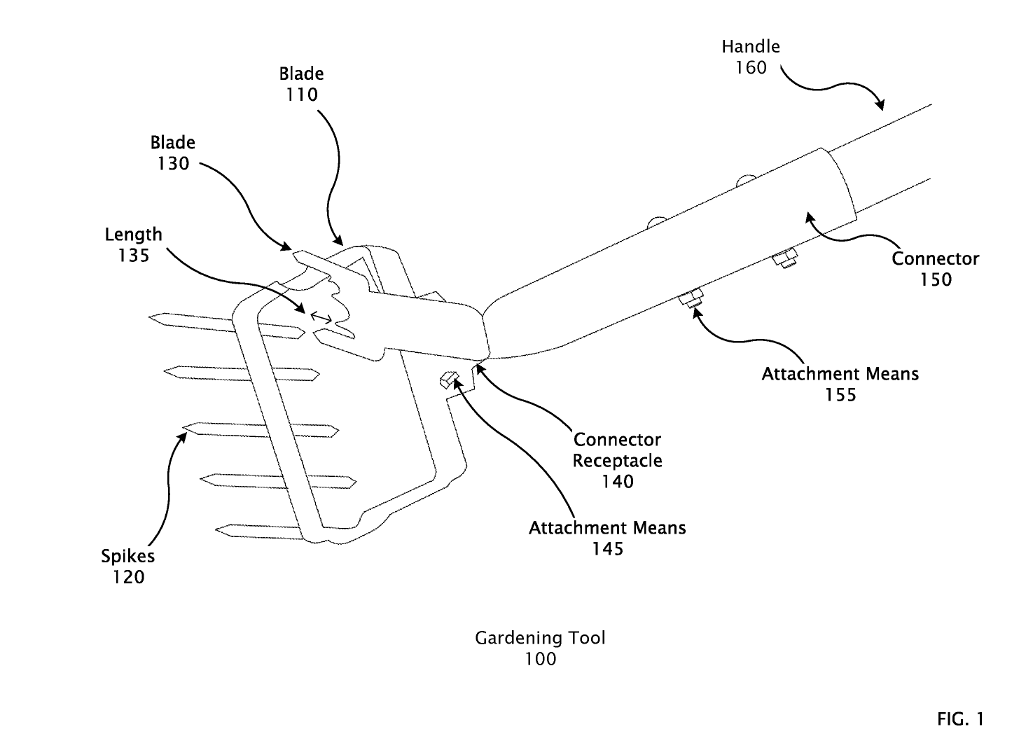

FIG. 1 is a top perspective view of a Gardening Tool 100, according to one embodiment. In this example, Gardening Tool 100 may comprise a head coupled to a handle by a connector piece. The head may include Blade 110, which may comprise blade having a generally rectangular shape, for example, or any other shape, and may be detachable or double-edged. Blade 110 may have a plurality of Spikes 120 which may run along the length of the base of Blade 110. Spikes 120 may also extend beyond the length of the base of Blade 110.

The head of Gardening Tool 100 may also include Blade 130, which may extend outwardly from the top portion of Blade 110. Blade 130 may include a plurality of prongs of varying lengths; for example, two smaller prongs may be flanked by two larger prongs. The distance from the tip of a smaller prong to the tip of a larger prong and may be approximately one inch, for example, as shown by Length 135.

Blade 130 may have a neck which extends to Connector Receptacle 140. Connector Receptacle 140 may comprise an opening located in the top portion of Blade 110 and at the base of Blade 130. Connector Receptacle 140 may be configured to receive Connector 150. Connector 150 may have a small tubing at a first end, which may fit inside Connector Receptacle 140. Connector 150 may have a hollow, elongated cylinder at a second end, which may receive Handle 160. Attachment Means 145, such as a bolt or screw, for example, may be placed through holes on the sides of Connector Receptacle 140 to securely attach Connector 150. Connector 150 may use Attachment Means 155, to securely attach Handle 160. Attachment means may include screws, bolts, clips, belts, hook and loop fasteners, magnets, or adhesives, for example. Handle 160 may comprise an elongated shaft and may be made in various sizes and shapes, such as round or oval, for example. Handle 160 may include an ergonomic grip or cushion, which may enhance friction and comfort for a user's hands.

Blade 110 may oscillate at any angle relative to Handle 160 upon pushing and pulling motions of Gardening Tool 100. The oscillation of Blade 110 may facilitate the loosening of soil or removal of weeds, roots, debris, or any other matter at or below the surface of the earth. Spikes 120 may allow Gardening Tool 100 to penetrate the earth at a deeper level or plane than conventional gardening tools such as gardening hoes, for example, and thus improve labor efficiency. Having multiple points of contact, Spikes 120 and Blade 110 may also improve efficiency in removing roots and other matter at the level of Blade 110. Blade 130 may also improve labor efficiency by loosening soil and removing weeds, roots, or debris, for example.

The smaller size of Gardening Tool relative to many conventional tools may improve efficiency for the use, transportation, and storage of the tools. A person skilled in the art will understand that any part of Gardening Tool may be made in various shapes and sizes, and out of various materials, such as wood, plastic, rubber, metal, or carbon fiber, or combinations thereof.

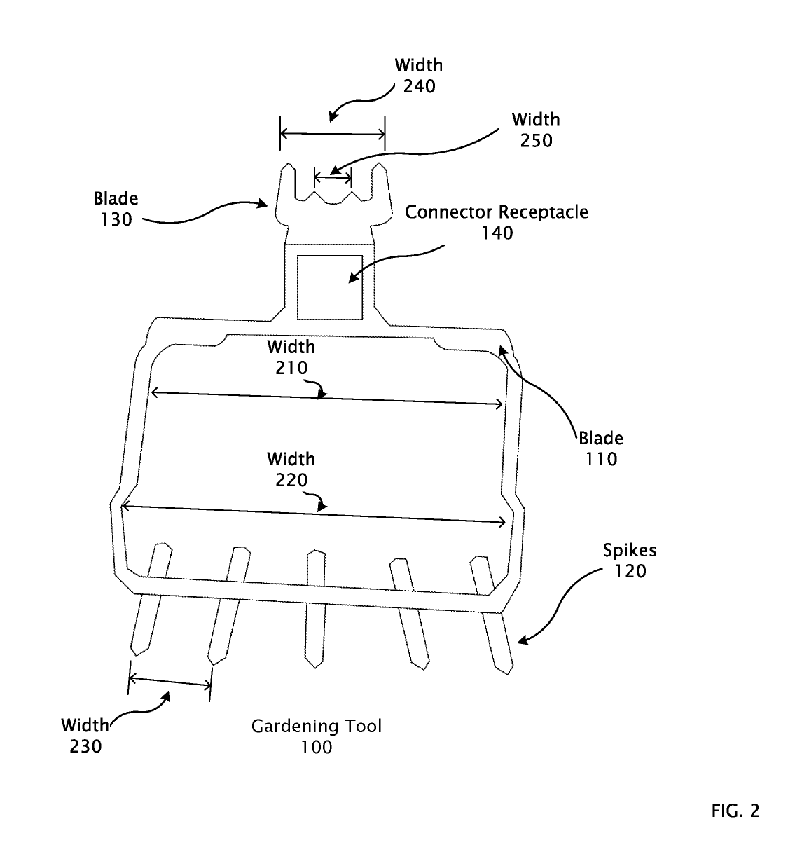

FIG. 2 is a front view of a Gardening Tool 100, according to one embodiment. In this example, the lateral sides of Blade 110 may have two or more different internal distances from one another. For example, Width 210 may be approximately 3.5 inches and Width 220 may be approximately 3.75 inches, for example. The Width 230 of spacing between Spikes 120 may be approximately ¾ to 13/16 inch, for example.

Connector Receptacle 140 may comprise a square-shaped opening, or an opening having any other shape, with dimensions of approximately ¾ inch on each side, for example. An attachment means such as a bolt may be placed through holes on the sides of Connector Receptacle 140 to securely attach Connector 150. Connector 150 may fit inside Connector Receptacle 140 with a gap and may be secured by the use of the attachment means. The hole receiving the attachment means may have a diameter of approximately ¼ inch, for example.

Gardening Tool 100 may also include Blade 130, which may outwardly extend from the top portion of Blade 110. Blade 130 may have a Width 240 of approximately one inch, for example. Blade 130 may include a plurality of prongs of varying lengths, for example, two smaller prongs flanked by two larger prongs. Width 250 between the smaller prongs of Blade 130 may be approximately ¼ inch, for example.

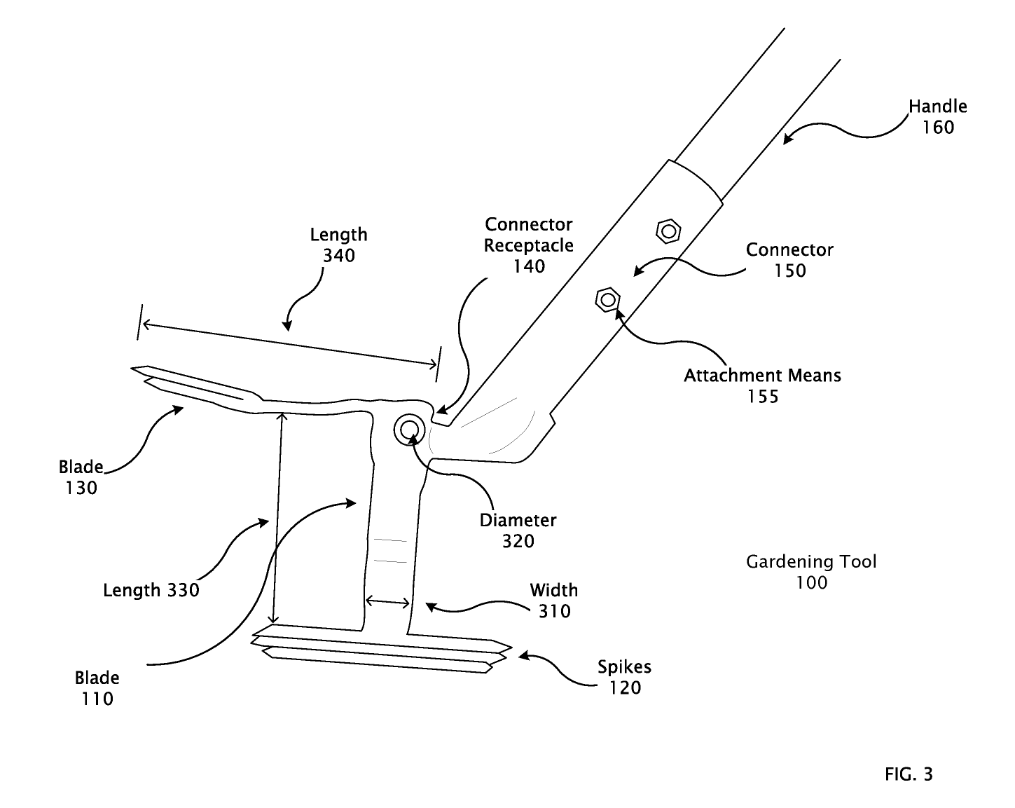

FIG. 3 is a side view of a Gardening Tool 100, according to one embodiment. In this example, each lateral side of Blade 110 may have a Width 310 of approximately ⅝ inch, for example. Connector 150 may have a small tubing at a first end which may fit inside Connector Receptacle 140. An attachment means such as a bolt may be placed through holes on the sides of Connector Receptacle 140 to securely attach Connector 150. The hole receiving the attachment means may have a Diameter 320 of approximately ¼ inch, for example.

Blade 110 may contain a plurality of Spikes 120, which may run along or beyond the length of the base of Blade 110, for example. The distance from the neck of Blade 130 to Spikes 120 may be approximately 2.5 inches, for example, as shown by Length 330. The distance from the tip of Blade 130 to the end of Connector Receptacle 140 may be approximately 4 inches, for example, as shown by Length 340.

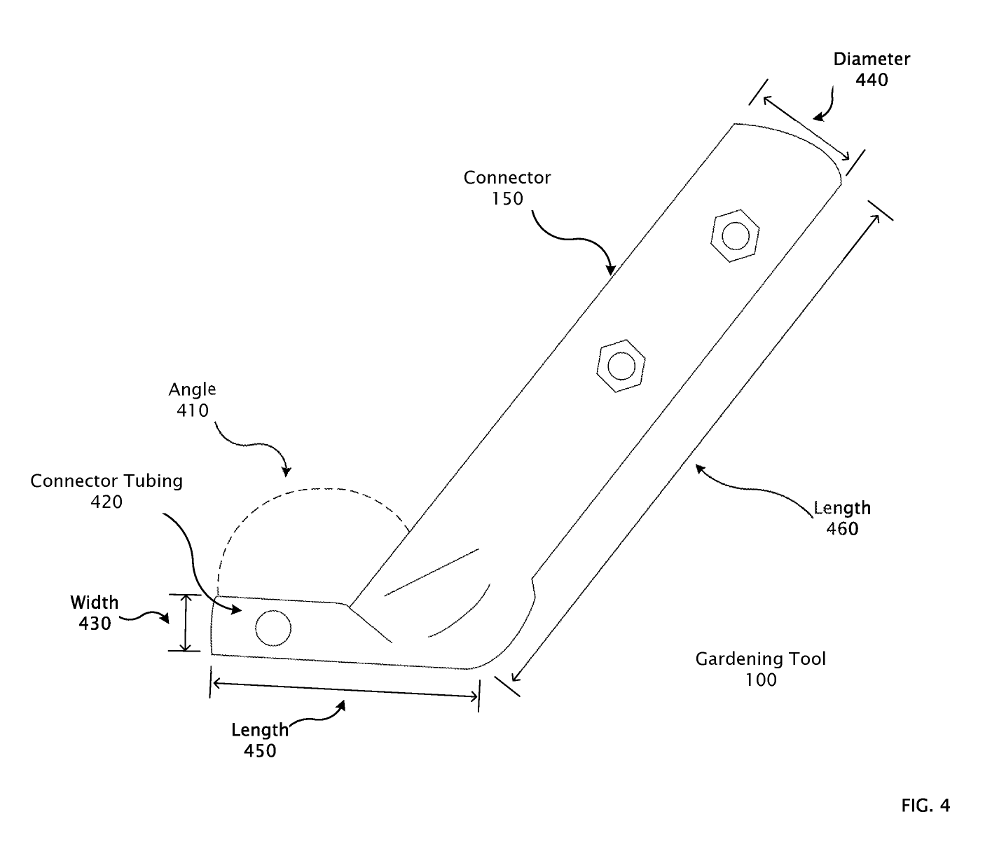

FIG. 4 is a side view of Connector 150 of Gardening Tool 100, according to one embodiment. Connector 150 may bend at an Angle 410 of approximately 45 to 50 degrees, for example. Connector Tubing 420 at the first end of Connector 150 may have a Width 430 of approximately ½ inch, for example. Connector Tubing 420 may be configured to fit into a connector receptacle by use of an attachment means such as a bolt, for example. A second end of Connector 150 may have a Diameter 440 of approximately 1⅛ inches, for example, and may be configured to receive a handle. Length 450 from the first end of Connector 150 to its bend may be approximately 2 inches, for example. Length 460 from the bend of Connector 150 to a second end of Connector 150 may be approximately 5 inches, for example.

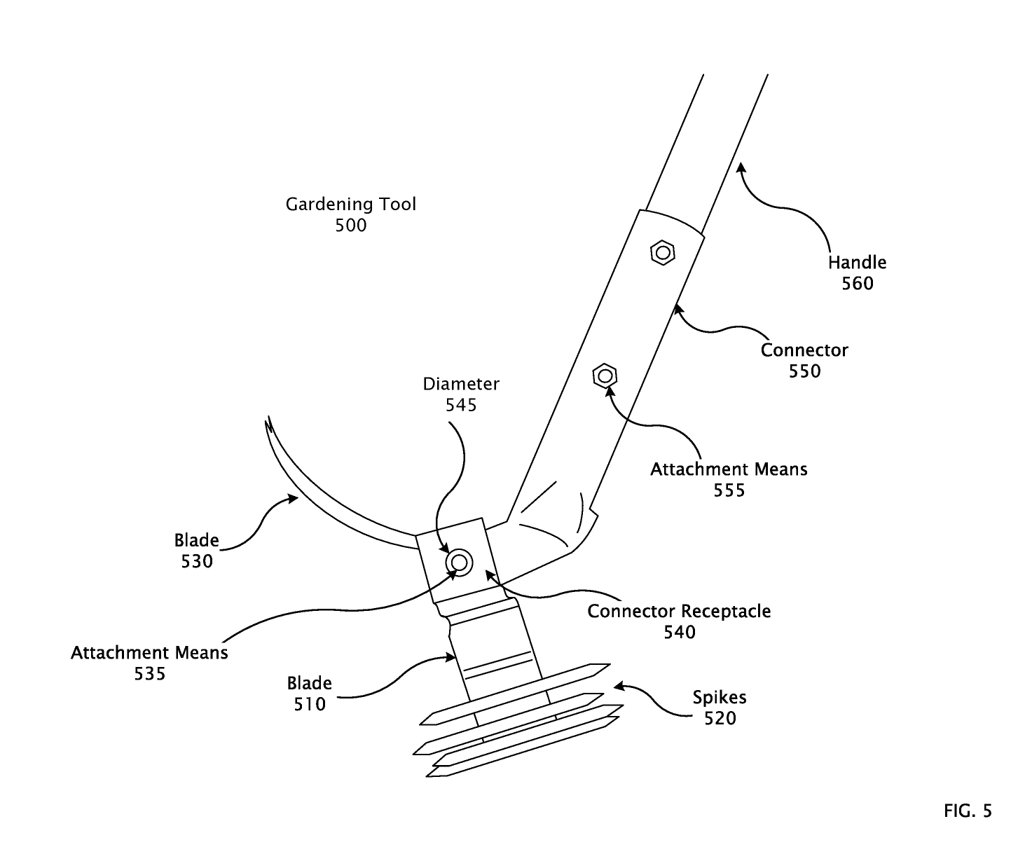

FIG. 5 is a side view of Gardening Tool 500, according to one embodiment. In this example, Gardening Tool 500 may include a head connected to Handle 560 by a Connector 550. The head may include a Blade 510 having a generally round shape or any other shape, for example. Blade 510 may have a plurality of Spikes 520 along its base or other location. The head may also include Blade 530 at a top portion of Blade 510.

Connector Receptacle 540 may be an opening located at a top of Blade 510 and base of Blade 530. Connector 550 may have a small tubing configured to fit into Connector Receptacle 540, at a first end. Connector 550 may comprise a hollow, elongated cylinder configured to fit Handle 560 at a second end. Connector 550 may securely attach to Connector Receptacle 540 by Attachment Means 535, which may be a bolt inserted through a hole having Diameter 545 of approximately ¼ inch, for example. Connector 550 may securely attach Handle 560 by Attachment Means 555, which may be a plurality of screws.

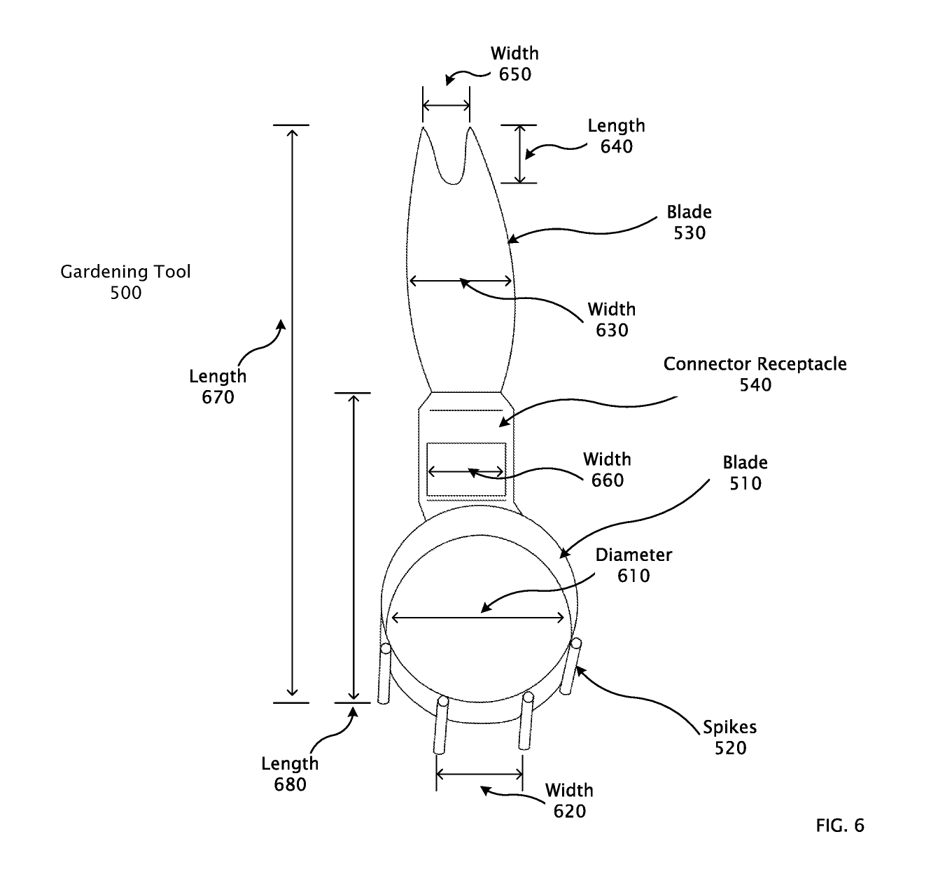

FIG. 6 is a front view of the head of a Gardening Tool 500, according to one embodiment. The head of Gardening Tool 500 may include a Blade 510 having a generally circular shape or any other shape, with a Diameter 610 of approximately 2 inches, for example. Blade 510 may include a plurality of Spikes 520, which may be spaced approximately ⅞ inches apart, as shown by Width 620, for example.

The head of Gardening Tool 500 may also include Blade 530, which may have a Width 630 of approximately 1 inch, for example. Blade 530 may have a plurality of prongs. In this example, Blade 530 may have two prongs which are approximately ⅝ inches tall, as shown by Length 640. The prongs may be spaced approximately ½ inch apart, as shown by Width 650 for example.

Connector Receptacle 540 may be located at the top of Blade 510 and base of Blade 530. Connector Receptacle 540 may comprise an opening configured to receive Connector 550, which may couple to Handle 560. Connector Receptacle 540 may be configured to receive a Connector 550 tubing having a Width 660 of approximately 1 inch, for example.

The Length 670 from the bottom of Spikes 520 to the top of the prongs of Blade 530 may be approximately 5.5 inches, for example. The Length 680 from the bottom of Spikes 520 to the top of Connector Receptacle 540 may be approximately 3 inches, for example.

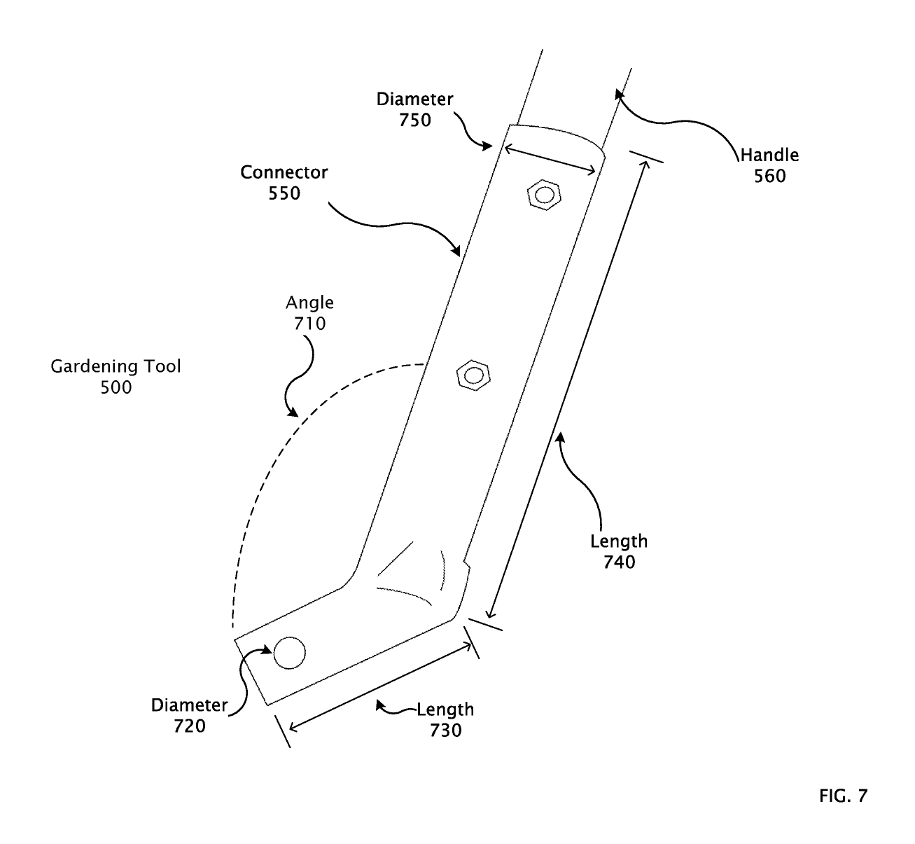

FIG. 7 is a side view of Connector 550 of Gardening Tool 500, according to one embodiment. Connector 550 may bend at an Angle 710 of approximately 45 degrees, for example. At a first end, Connector 550 may have tubing configured to fit inside a Connector Receptacle 540. Connector 550 may secure to a Connector Receptacle 540 by an Attachment Means 535, which may be a bolt, which may fit through a hole having a Diameter 720 of approximately ¼ inch, for example. The length from the first end of Connector 550, containing the tubing, to the location of the bend of Connector 550 may be Length 730 of approximately 2 inches, for example. Length 740 from the bend to the top of Connector 550 may be approximately 5 inches, for example. Connector 550 may have a diameter 750 of approximately 1¼ inches, for example. Connector 550 may be configured to couple to Handle 560 at a second end.

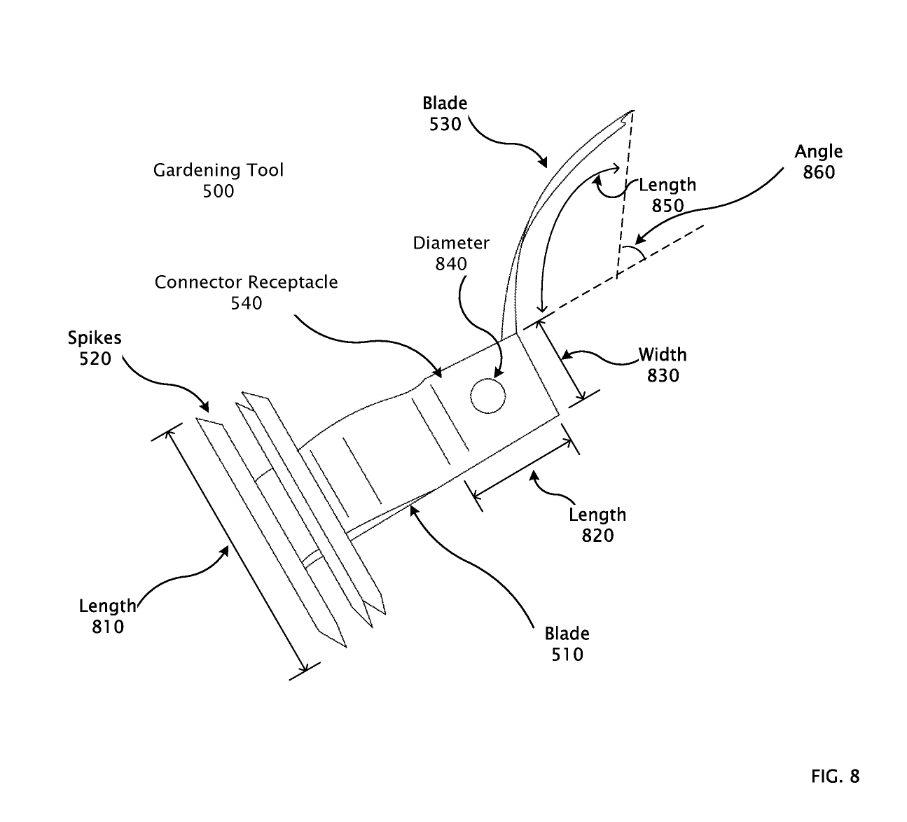

FIG. 8 is a side view of a head of Gardening Tool 500 according to one embodiment. Blade 510 may have a plurality of Spikes 520. Spikes 520 may have a Length 810 of approximately 2¾ inches, for example. Connector Receptacle 540 may have Length 820 of approximately 1 inch and Width 830 of approximately 1 inch, for example. Connector Receptacle 540 may secure to a connector piece by an Attachment Means 535, such as a bolt, which may fit through a hole having a Diameter 840 of approximately ¼ inch, for example. Length 850 of Blade 530 may be approximately 3 inches, for example. Blade 530 may open at an Angle 860 of approximately 55 degrees, for example.

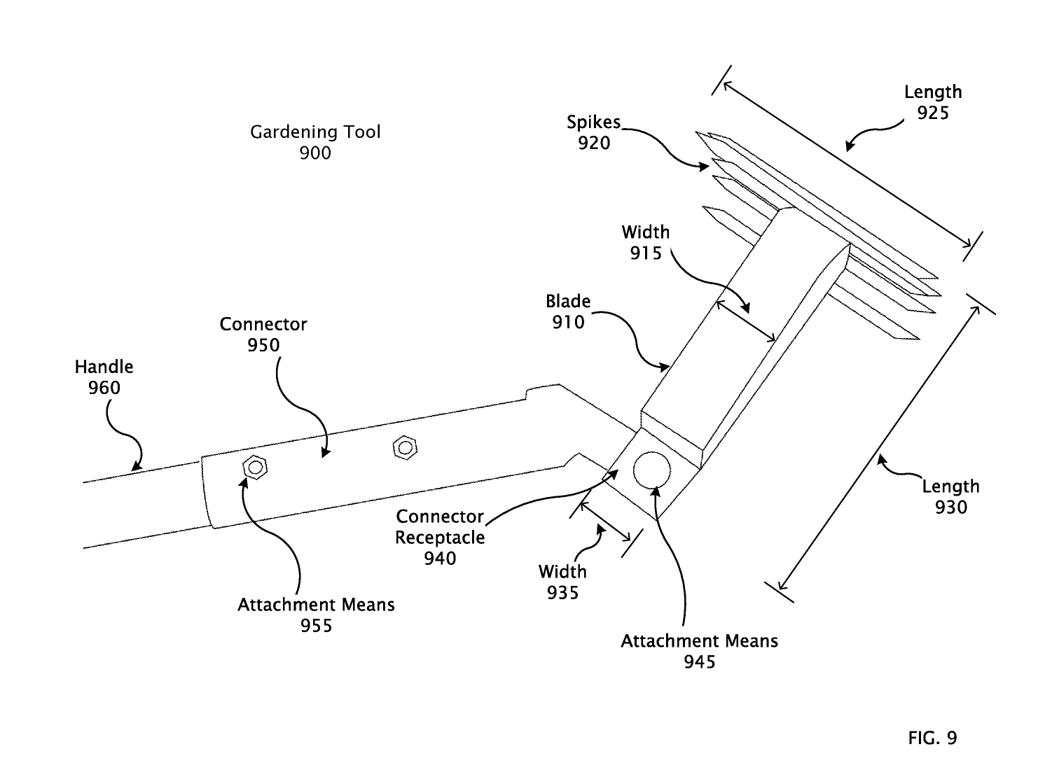

FIG. 9 is a side view of a Gardening Tool 900, according to one embodiment. The head of Gardening Tool 900 may include Blade 910, which may have a Width 915 of approximately 1 inch, for example. Blade 910 may have a plurality of Spikes 920. Spikes 920 may each have a Length 925 of approximately 3¾ inches, for example. The head of Gardening Tool 900 may also include Connector Receptacle 940, and the Length 930 from Spikes 920 to the end of Connector Receptacle 940 may be approximately 4¾ inches, for example. Connector Receptacle may have a Width 935 of approximately 1 inch, for example. Connector Receptacle 940 may be configured to receive Connector 950. Connector 950 may have a small tubing at a first end which may be configured to fit inside Connector Receptacle 940. Connector 950 may couple to Connector Receptacle 940 by an Attachment Means 945, for example, a bolt. Connector 950 may have a hollow, elongated cylinder at its second end, which may be configured to fit Handle 960. Handle 960 may be securely attached to Connector 950 by Attachment Means 955, for example, screws, bolts, clips, belts, hook and loop fasteners, magnets, or adhesives.

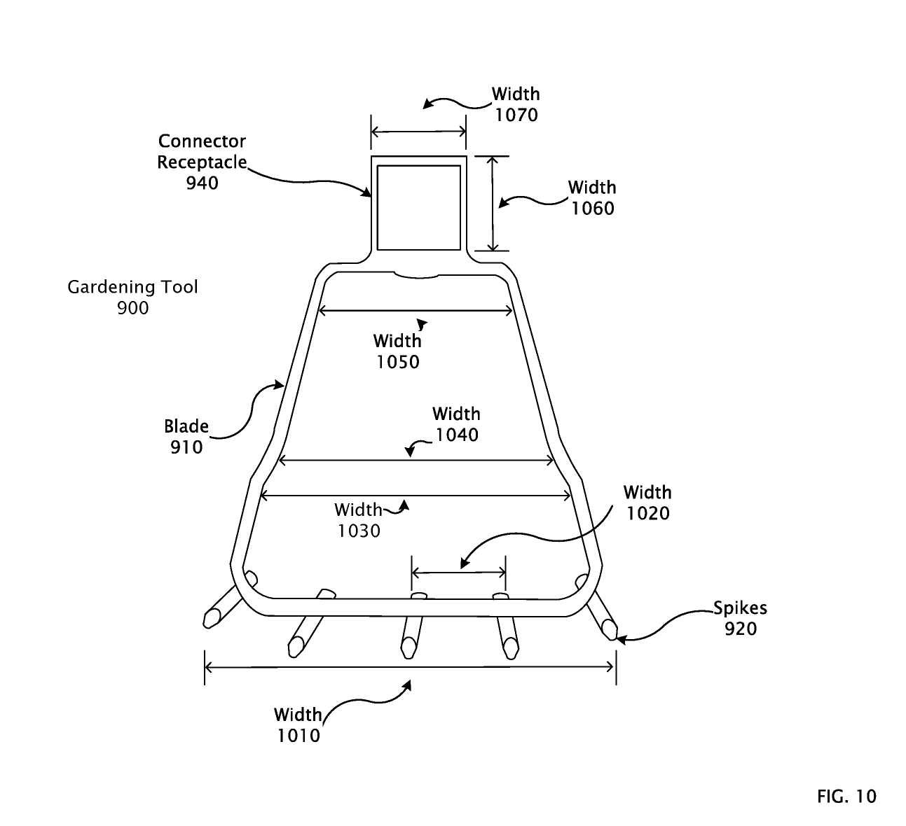

FIG. 10 is a front view of a Gardening Tool 900 head, according to one embodiment. Blade 910 may have a generally triangular shape or any other shape, for example. Spikes 920 may line the base of Blade 910 for a Width 1010 of approximately 4 inches, for example, or they may extend beyond the base of Blade 910. Spikes 920 may be spaced apart a Width 1020 of approximately ⅞ inch, for example. Blade 910 may have at least three internal widths. Width 1030 may be approximately 3½ inches, Width 1040 may be approximately 3 inches, and Width 1050 may be approximately 2 inches, for example. Connector Receptacle 940 may comprise an opening, such as a square-shaped opening, with a Width 1060 of approximately 1 inch and a Width 1070 of approximately 1 inch, for example.

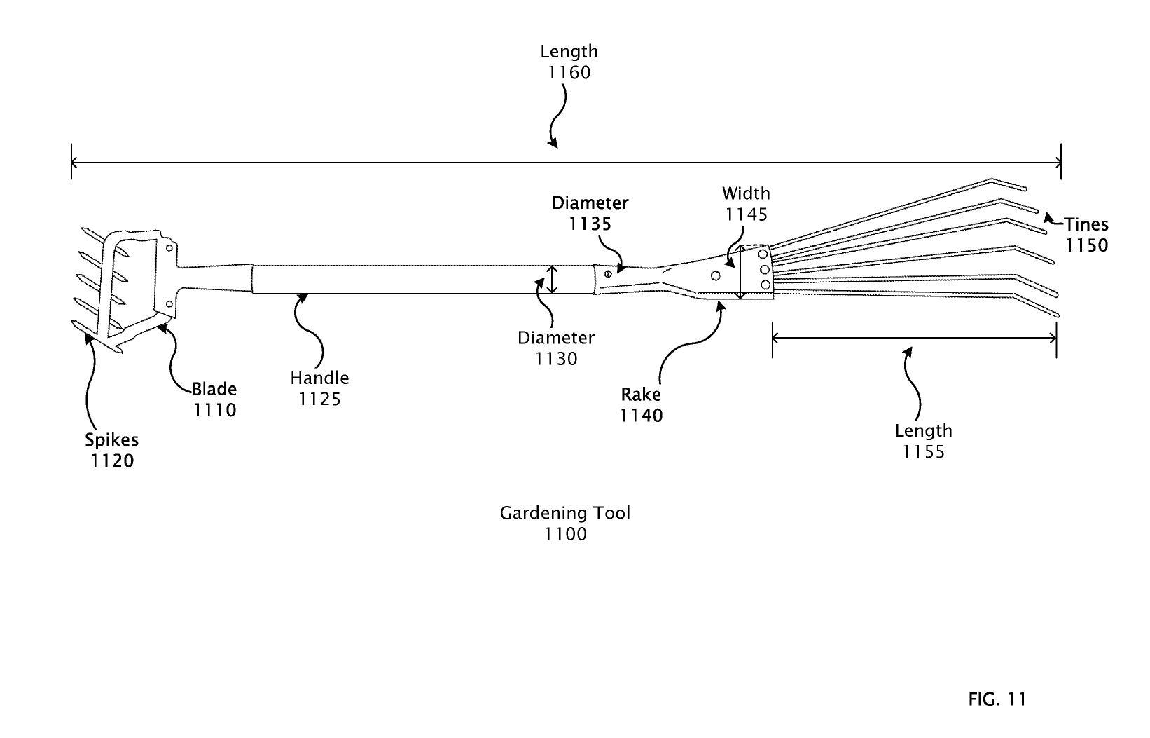

FIG. 11 is a top perspective view of a Gardening Tool 1100, according to one embodiment. Blade 1110 may have a plurality of Spikes 1120. Handle 1125 may couple to Blade 1110 at a first end and to Rake 1140 at its second end. Handle 1125 may have a Diameter 1130 of approximately ⅞ inch, for example. Diameter 1135 may be approximately 1 inch at the location where Rake 1140 couples to Handle 1125, for example. The head of Rake 1140 may have a Width 1145 of approximately 1⅞ inch, for example. A plurality of Tines 1150 may protrude from the head of Rake 1140. Tines 1150 may have a Length 1155 of approximately 9 inches, for example. The full Length 1160 of Gardening Tool 1100 may be approximately 30 inches, for example.

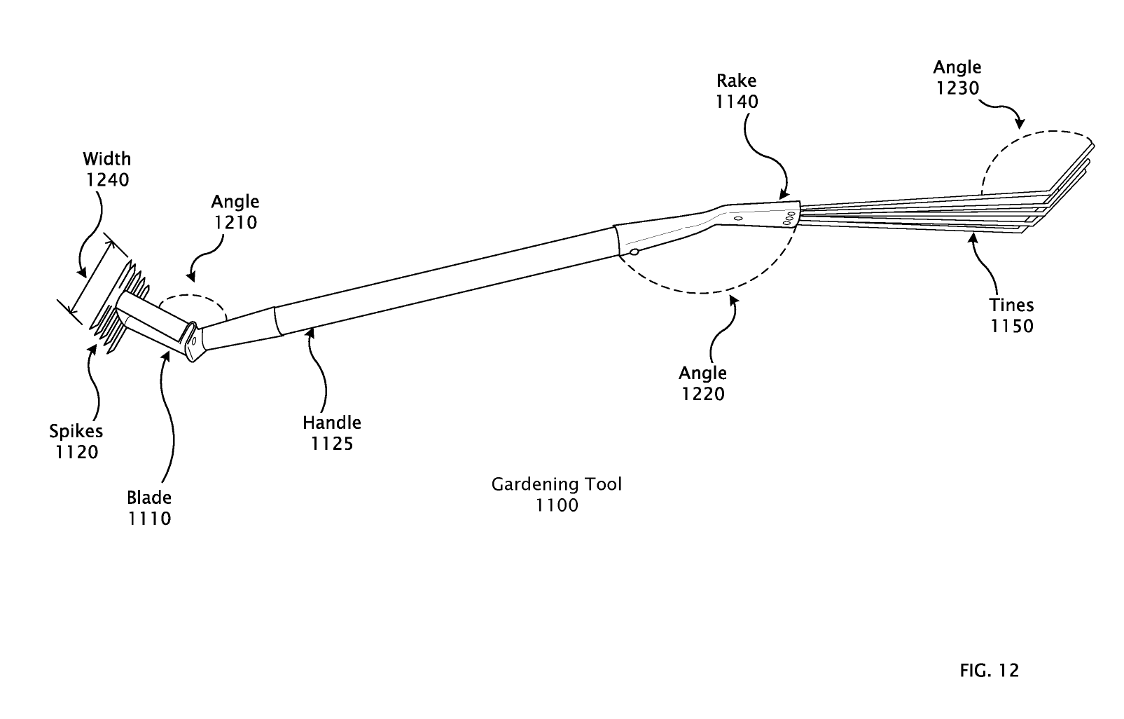

FIG. 12 is a side perspective view of a Gardening Tool 1100, according to one embodiment. Blade 1110 may have a plurality of Spikes 1120. Spikes 1120 may have a Width 1240 of approximately 2½ inches, for example. Blade 1110 may bend at an Angle 1210 of approximately 152 degrees relative to Handle 1125, for example. Rake 1140 may bend at an Angle 1220 of approximately 170 degrees relative to Handle 1125, for example. Tines 1150 may bend at an Angle 1230 of approximately 50 degrees, for example.

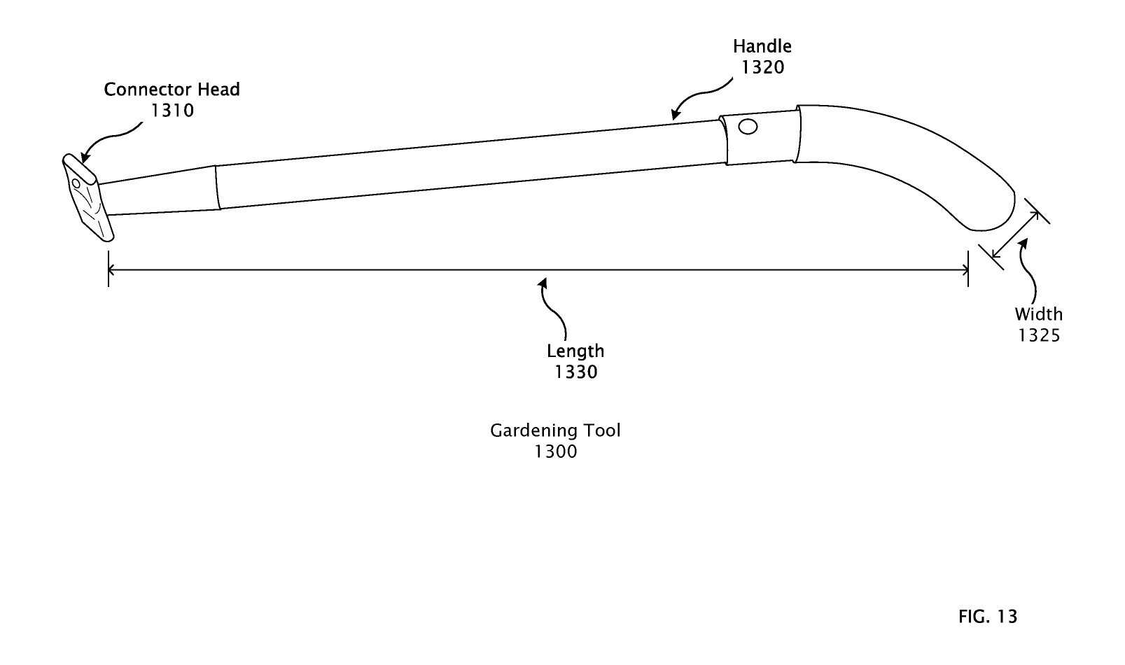

FIG. 13 is a side perspective view of a Gardening Tool 1300, according to one embodiment. Gardening Tool 1300 may include a Connector Head 1310 that is generally flat and rectangular in shape, or any other shape. Connector Head 1310 may couple to Handle 1320, which may have a curved end, for example. Handle 1320 may have Width 1325 of approximately 1¼ inch, for example. Length 1330 from the bottom of Connector Head 1310 to the end of Handle 1320 may be approximately 18 inches, for example. Connector Head may be configured to securely attach other tools such as a blade, for example.

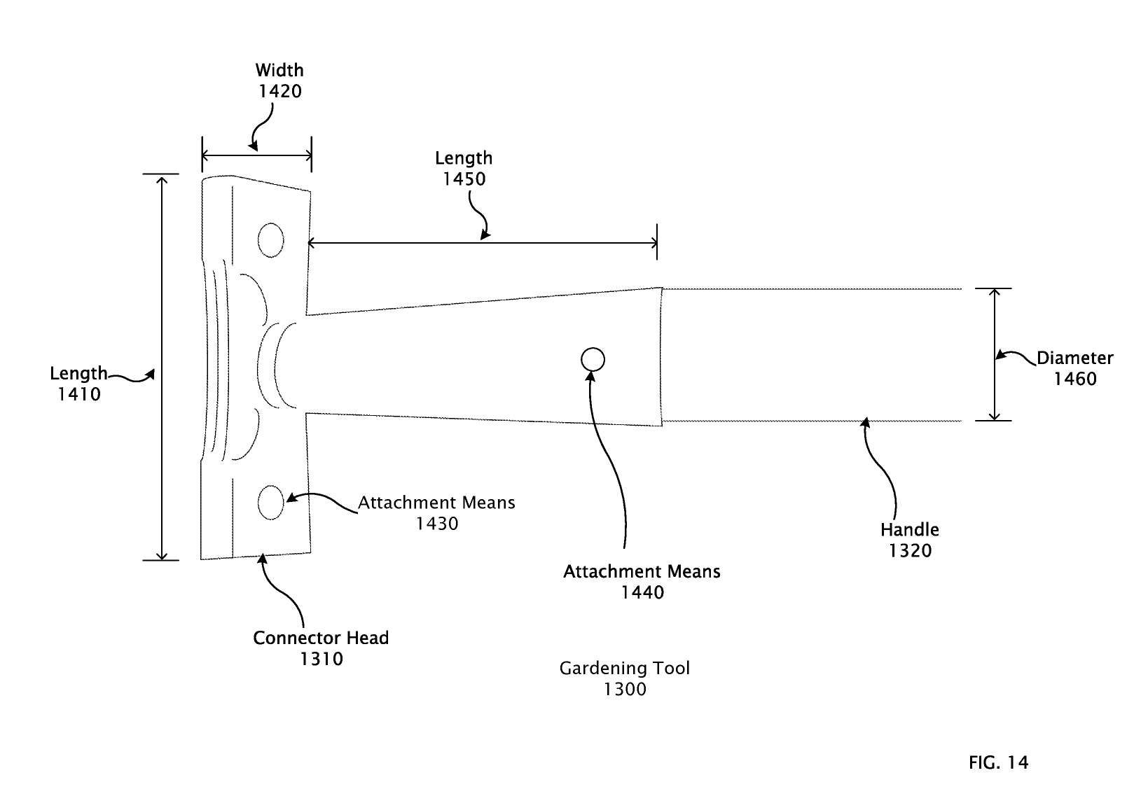

FIG. 14 is a perspective view of a Gardening Tool 1300, according to one embodiment. The top piece of Connector Head 1310, which may have a generally flat and rectangular shape or any other shape, may have Length 1410 of approximately 2½ inches and Width 1420 of approximately ⅞ inch, for example. Connector Head 1310 may have Attachment Means 1430, which may comprise screws or bolts, for example. Attachment Means 1430 may be used to securely attach tools, such as a blade, for example, to Connector Head 1310. Connector Head 1310 may also have Attachment Means 1440, which may comprise a screw or bolt, for example. Attachment Means 1440 may securely attach Connector Head 1310 to Handle 1320. Length 1450 of Connector Head 1310 may be approximately 2⅜ inches, for example. Handle 1320 may have a Diameter 1460 of approximately ⅞ inch, for example.

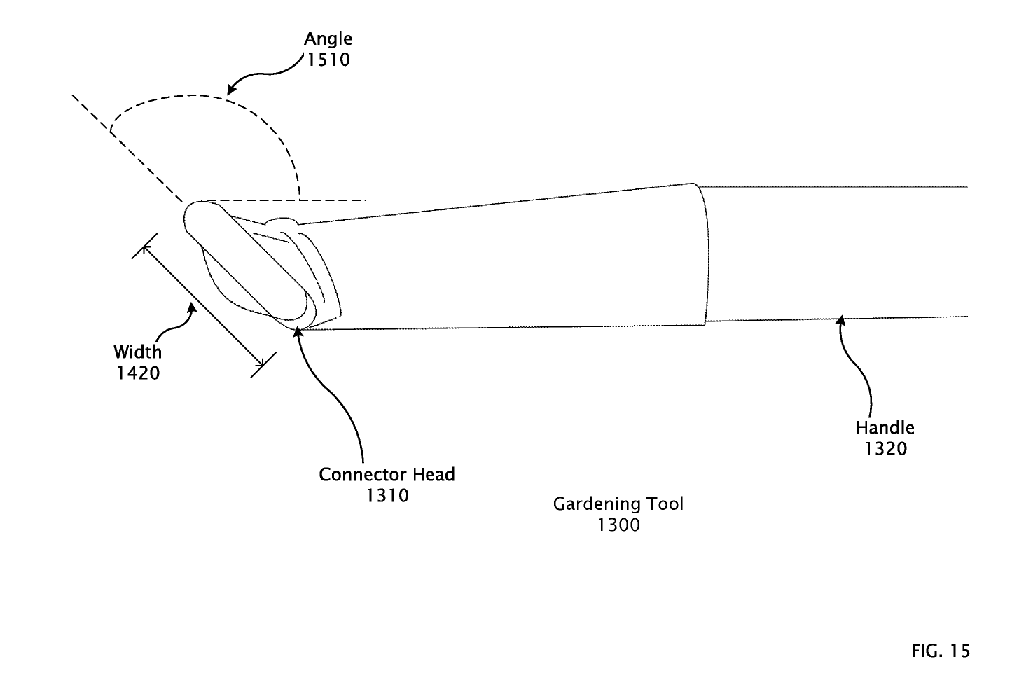

FIG. 15 is a side view of a Gardening Tool 1300, according to one embodiment. Connector Head 1310 may have Width 1420 of approximately ⅞ inch, for example. The rectangular flat portion of Connector Head 1310 may bend at an Angle 1510 of approximately 45-50 degrees relative to the remaining elongated portion of Connector Head 1310, for example. Connector Head 1310 may couple to Handle 1320.

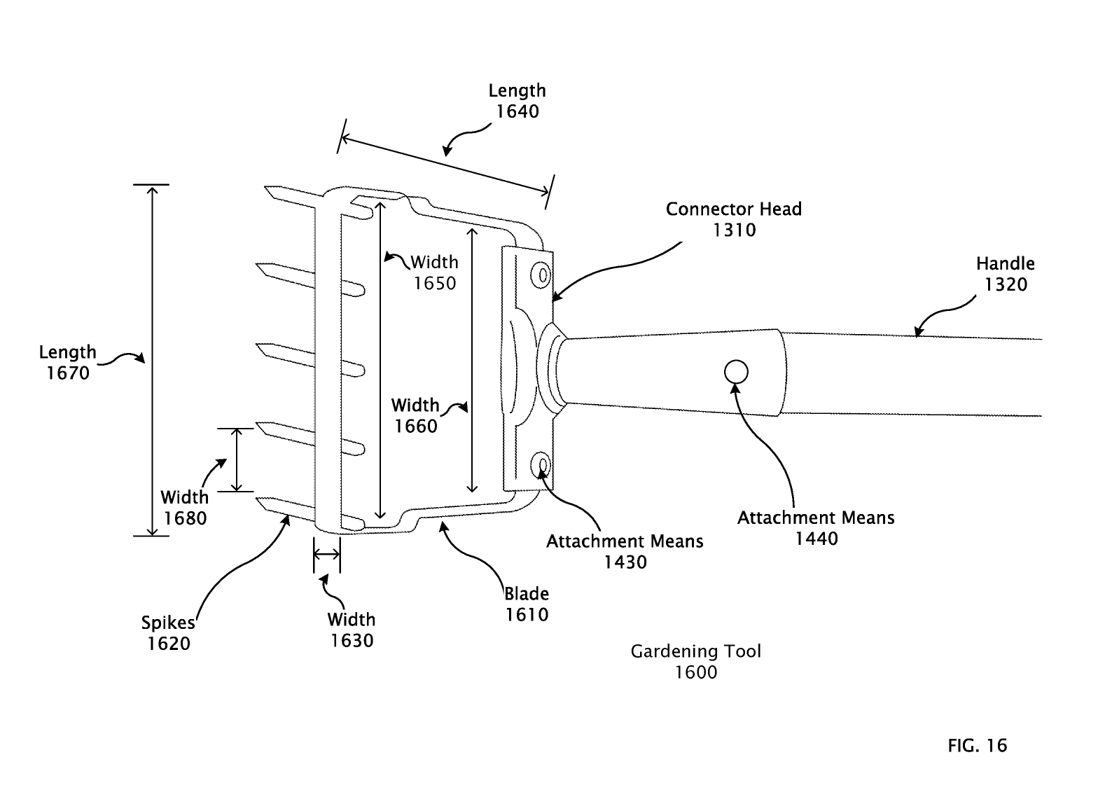

FIG. 16 is a side view of a Gardening Tool 1600, according to one embodiment. Connector Head 1310 may couple to Blade 1610 at a first end. Blade 1610 may securely attach to Connector Head 1310 by Attachment Means 1430, which may be screws or bolts, for example. Connector Head 1310 may couple to Handle 1320 at its second end by Attachment Means 1440, which may be screws or bolts, for example. Blade 1610 may have Width 1630 of approximately ⅝ inch along its base and Length 1640 of approximately 2½ to 3½ inches along its sides, for example. The internal dimensions of Blade 1610 may include Width 1650 of approximately 3½ inches and Width 1660 of approximately 3¼ inches, for example. Blade 1610 may have Spikes 1620 which may be located along the base of Blade 1610 for a Length 1670 of approximately 3⅝ inches, for example. Spikes 1620 may be spaced approximately ¾ inch apart, as shown by Width 1680, for example.

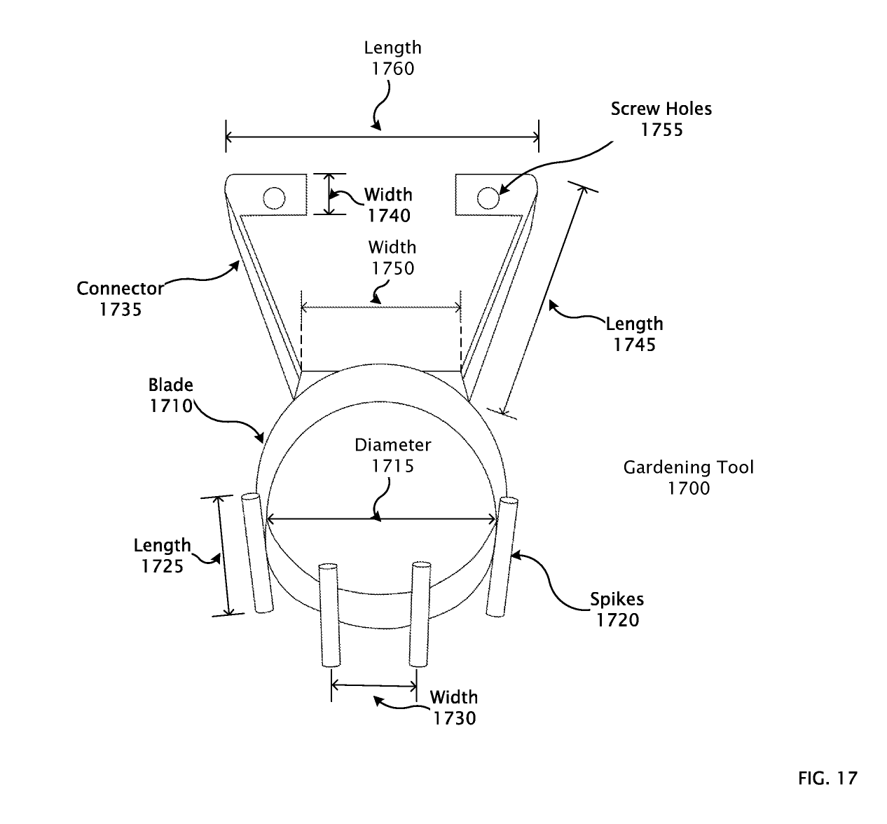

FIG. 17 is a front perspective view of a Gardening Tool 1700, according to one embodiment. The head of Gardening Tool 1 700 may include a Blade 1710, which may have a generally circular shape, or any other shape. Blade 1710 may have a Diameter 1715 of approximately 2 inches, for example. Blade 1710 may have a plurality of Spikes 1720. Spikes 1720 may have a Length 1725 of approximately 2¾ inches, for example. Spikes 1720 may be spaced approximately ⅞ inch apart, for example, as shown by Width 1730.

The head of Gardening Tool 1700 may also include Connector 1735, which may comprise two brackets configured to couple to Connector Head 1310, for example. Connector 1735 may have a generally inverted triangular shape, or any other shape. Connector 1735 may have two sides, each comprising a bent strip of metal, or any other material, having Width 1740 of approximately ¾ inch, for example. Connector 1735 may have two sides with Length 1745 of approximately 2 inches, for example, up to its bend. Connector 1735 may have a Width 1750 of approximately 1½ inch, for example, at its base. Connector 1735 may include Screw Holes 1755, which may be configured to fit any attachment means, such as screws or bolts, which may be used securely attach Connector Head 1735 to Connector Head 1310, for example. Connector 1735 may have a Length 1760 of approximately 2¾ inches, for example, from one bend to the other.

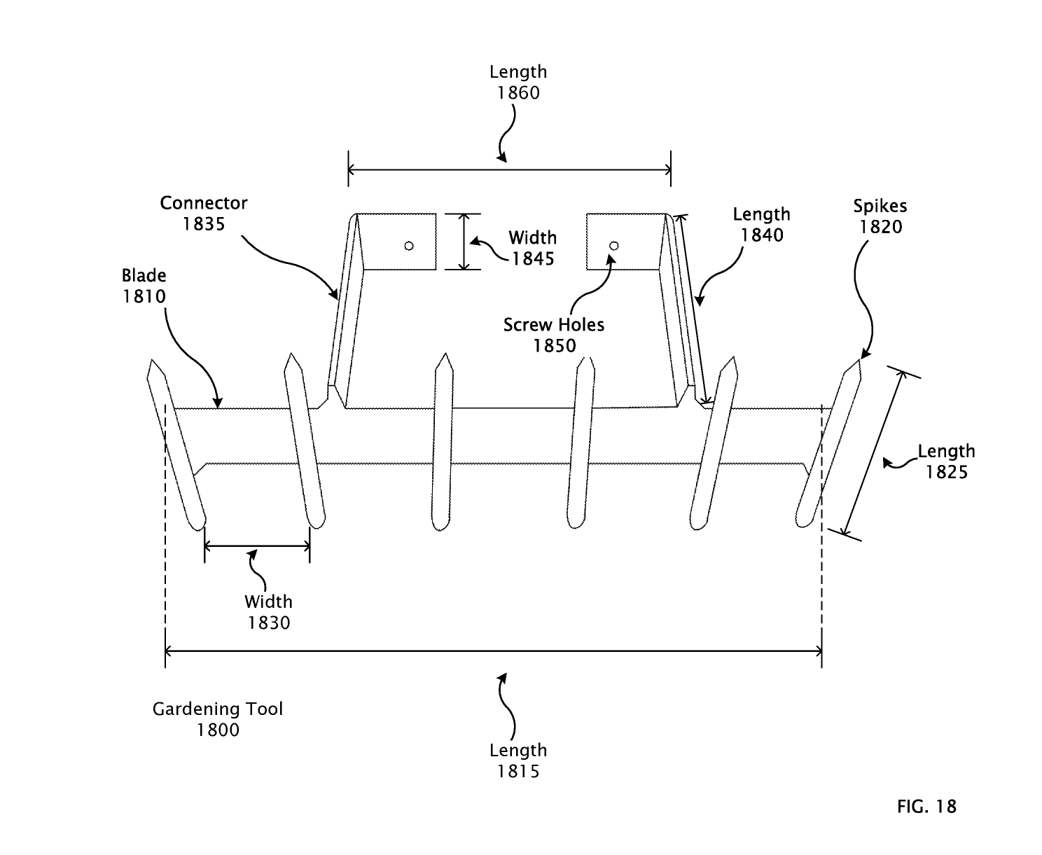

FIG. 18 is a bottom perspective view of a Gardening Tool 1800, according to one embodiment. Gardening Tool 1800 may comprise a head having Blade 1810 with Length 1815 of approximately 5 inches, for example. Blade 1810 may have a plurality of Spikes 1820 along its base or any other location. Spikes 1820 may each have Length 1825 of approximately 2½ inches, for example. Spikes 1820 may be spaced apart a Width 1830 of approximately 1 inch, for example. The head of Gardening Tool 1800 may also include Connector 1835, which may comprise two brackets configured to couple to Connector Head 1310, for example. Connector 1835 may have sides with Length 1840 of approximately 2 to 3 inches and Width 1845 of approximately ¾ inch, for example. Connector 1835 may have Screw Holes 1850, which may be configured to fit any attachment means, such as screws or bolts, for example, which may be used to securely attach Connector 1835 to Connector Head 1310, for example. Connector 1835 may have a Length 1860 of approximately 2¾ inches, for example, from one bend to the other.

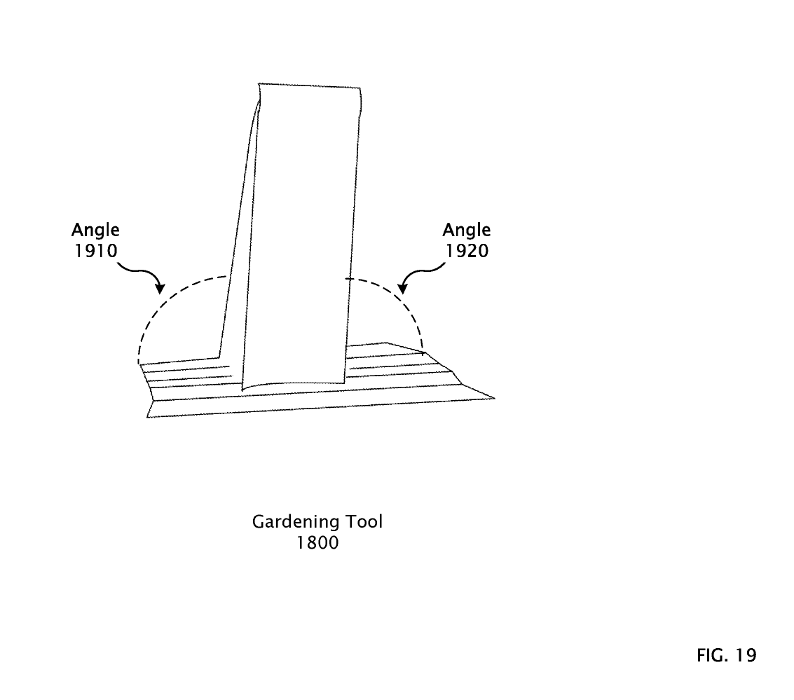

FIG. 19 is a side view of a Gardening Tool 1800, according to one embodiment. Connector 1835 may bend at Angle 1910 of approximately 110 degrees and Angle 1920 of approximately 80 degrees relative to Spikes 1820, for example.

1. A gardening tool, comprising:
a head at a first end, the head comprising a blade;
an elongated shaft at a second end; and
a means to connect the head to the elongated shaft.

2. The gardening tool of claim 1, wherein the means to connect the head to the elongated shaft is a connector piece, comprising:
a tubing at a first end of the connector piece; and
an elongated cylinder at a second end of the connector piece.

3. The connector piece of claim 2, wherein the tubing at the first end of the connector piece is configured to fit into a connector receptacle, the connector receptacle coupled to the head of the gardening tool.

4. The connector piece of claim 2, wherein the elongated cylinder at the second end of the connector piece is configured to receive the elongated shaft.

5. The gardening tool of claim 1, wherein the elongated shaft is composed of materials selected from the list containing wood, plastic, rubber, metal, or carbon fiber.

6. The gardening tool of claim 1, wherein the head includes a blade having a generally rectangular shape.

7. The gardening tool of claim 1, wherein the head includes a blade having a generally circular shape.

8. The gardening tool of claim 1, wherein the head includes a blade having a generally triangular shape.

9. The gardening tool of claim 1, wherein the head includes a double-edged blade.

10. The gardening tool of claim 1, wherein the head includes a detachable blade.

11. The gardening tool of claim 1, wherein the head includes a plurality of spikes on a base of the blade.

12. The gardening tool of claim 1, wherein the head includes a plurality of spikes which extend beyond a base of the blade.

13. The gardening tool of claim 1, wherein the connector piece is securely attached to the connector receptacle by an attachment means from the list containing screws, bolts, clips, belts, hook and loop fasteners, magnets, and adhesives.

14. The gardening tool of claim 1, wherein the connector piece is securely attached to the elongated shaft by an attachment means from the list containing screws, bolts, clips, belts, hook and loop fasteners, magnets, and adhesives.

15. The gardening tool of claim 1, wherein the head includes a blade with a plurality of prongs.

16. The gardening tool of claim 1, wherein the head includes a blade with a plurality of prongs of varying lengths.

17. The gardening tool of claim 1, wherein the head is composed of materials selected from the list containing wood, plastic, rubber, metal, and carbon fiber.

18. A gardening tool, comprising:
a head at a first end, the head comprising a means for attaching a blade;
an elongated shaft at a second end; and
a means to connect the head to the elongated shaft.

19. The gardening tool of claim 18, wherein the head is configured to securely attach a blade by an attachment means selected from the list containing screws, bolts, clips, belts, hook and loop fasteners, magnets, and adhesives.
